(19) United States
(12) Patent Application Publication
(10) Pub. No.: US 2008/0010160 A1
(43) Pub. Date: Jan. 10, 2008

(54) Point of sale specific interface

(76) Inventors: Thomas L. Bridges, Melbourne Beach, FL (US); Anthony P. Galluscio, Indialantic, FL (US); David A. Boley, Melbourne Beach, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/653,169

(22) Filed: Jan. 12, 2007

Related U.S. Application Data
(63) Continuation-in-part of application No. 11/606,530, filed on Nov. 30, 2006.
Application No. 11/606,530 is a continuation-in-part of application No. 11/454,270, filed on Jun. 16, 2006.
(60) Provisional application No. 60/872,196, filed on Dec. 1, 2006.

(51) Int. Cl. G06Q 20/00

(52) U.S. Cl. 705/16

(57) ABSTRACT

An interface with a point of sale (POS) system at a place of business, and more specifically, an interface that is external to the POS software and capable of interfacing disparate POS systems. A point of sale specific interface (POSSI), which functions to bidirectionally translate POS system specific data that is communicated from the existing POS system database into generic transaction/update upload bundles that are communicated to the business server software (BSS). Having bidirectional translating capability, the POSSI may provide communications between a central subsystem database of a consumer loyalty system, accessible via the BSS and an internet connection, and disparate pre-existing POS systems at various places of business. Acting as a go-between, the POSSI communicates with the BSS by means of a generic interface, while the POSSI communicates with disparate POS systems by means of a system specific interface.

### CROSS REFERENCE TO RELATED APPLICATIONS

This application claims the benefit of provisional patent application Ser. No. 60/872,196, and filed with the UPSTO on Dec. 1, 2006, which is incorporated by reference in its entirety. This application is also a continuation-in-part of U.S. utility application Ser. No. 11/606,530, and filed with the USPTO on Nov. 30, 2006, which is incorporated by reference in its entirety. This application is further a continuation-in-part of U.S. utility application Ser. No. 11/454,270, filed with the USPTO on Jun. 16, 2006, which is incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates to an interface with point of sale (POS) systems at places of business, and more specifically, the present invention relates to an interface that is external to the POS software and capable of interfacing disparate POS systems.

2. Background Art

Point of sale (POS) terminals typically have a card reading device, a numeric keypad, an LCD display, a receipt printer, and a modem. A typical transaction sequence is as follows: the terminal will read a customer card, prompt the terminal operator to enter some information using the keypad, print a receipt of the transaction, and send a summary of the transaction to a central server via modem. Cards can be magnetic stripe, barcode, or smart cards.

The most popular POS terminal applications consist of credit/debit card transactions and gift card transactions. There exist a smaller, yet growing, number of loyalty and frequent shopping applications that have been programmed to run on POS terminals. These loyalty applications are individually created and then programmed and deployed on a per merchant basis. Such single-purpose applications significantly limit any flexibility or merchant level customization. One size is expected to fit all and as a result the application is not optimized for any of the merchants. Further, any significant changes to the application requires a complete reload of the terminal software and in most cases requires a service rep to go out to the merchant's physical location to swap out systems.

U.S. patent application 2003/0208403 to Fisher et al. discloses a merchant configurable loyalty system that is an “out-of-the-box”, turnkey retail marketing solution that empowers individual merchants to set up and configure their own customer loyalty applications using their own unique cards or tokens, or by enrolling compatible cards and/or tokens from other programs. Such a programmable POS terminal which receives operating instructions from the merchant by way of a central server would prove quite costly to smaller business owners having to replace their current POS systems.

Given the current state of the art, as described above, a need exists for an interface that is external to the POS software at a place of business and does not require replacing or substantially modifying the existing POS software system. Externalizing such an interface from the POS software would provide economical savings to the individual business owner, and allow for the expansion and use of pre-existing conventional POS systems with new applications, such as the consumer loyalty systems disclosed herein and incorporated by reference. Such a needed and beneficial external POS interface would be required to be capable of uniquely interfacing with a plurality of businesses, each having disparate point of sale systems currently in use within the marketplace.

### BRIEF SUMMARY OF THE INVENTION

In accordance with one embodiment an interface for communicating with disparate point of sale systems, comprising a software module that comprises business server software; and a point of sale specific interface for bidirectionally translating communications between the business server software and the disparate point of sale system.

### BRIEF DESCRIPTION OF THE DRAWINGS

FIG. 1 depicts a flow diagram of the possible interactions between an interface of the present invention and the common components of a business server.

FIG. 2 depicts a flow diagram of a directive bundle being communicated from the business server software to the point of sale database via the point of sale specific interface of the present invention.

FIG. 3 depicts a flow diagram of a reward/transaction upload bundle being communicated from the point of sale database to the business server software via the point of sale specific interface of the present invention.

FIG. 4 depicts a flow diagram of the various stages of creating an interface of the present invention.

### DETAILED DESCRIPTION OF THE INVENTION

The present invention relates to providing and implementing a point of sale (POS) independent interface at places of business, and more specifically, the present invention relates to an interface that is external to the POS software and capable of interfacing with disparate POS systems.

The interface of the present invention may be utilized by a consumer loyalty system to, in some generic way, tell a specific pre-existing POS system how to give discounts to specific consumers. A variety of discounts are available but for the purposes of rewards, incentives and gift cards, discounts may include, but are not limited to, % off total sale, % off particular item (100% is a free item), cash credit to total sale of a certain amount or higher, cash credit off total sale cash back, and cash credit off total sale store credit. One limitation is the vast difference between existing POS software systems, since some POS systems allow certain particular credits/rewards/incentives that other POS systems may not allow.

The commonality between disparate POS systems is that they all rely on some sort of database to store items and prices. Another commonality is that POS systems also get point of sale direction from a relational database. Relational database management systems are well known in the art and include, but are not limited to, MySQL®, Sybase®, Oracle® and Microsoft® SQL-Server, and the like.

To solve the problem of interfacing with disparate POS systems, an abstraction comprising a software module is created between the functionality that is specific to each of the disparate POS systems and the functionality that is generic to the POS systems. The software module comprises business server software (BSS), which is generic software having a generic interface and the BSS need only to be created once. The software module further comprises a point of sale specific interface (POSSI) designed to interact with specific pre-existing POS systems. Typical POS systems include point of sale software for managing a point of sale database, which in turn contains point of sale system specific data. The interaction between the POSSI and POS system most often includes, but is not limited to, inserting and retrieving records from the POS database.

There are basically three types of interfaces to encounter. First, Application Programmer's Interfaces (API) comprise software that intentionally provides an interface that allows third-party applications to interface with the POS system. Third party applications can typically add and delete items from the database among many other possible capabilities. Second, User Callback Interfaces comprise software that calls hooks (user functions with a specific call format) that are normally stubbed out (i.e. they normally do nothing). Third-party developers can then develop code that is inserted at the hooks to interface with externally developed software systems. Third, Closed Box Interfaces comprise POS systems having databases that do not provide a pre-planned interface mechanism. These closed box systems can be very difficult, though not impossible to interface when the database format and schema are proprietary and unpublished. However, closed box systems often use standard relational databases and some publish the POS database schema, making it easier to interface.

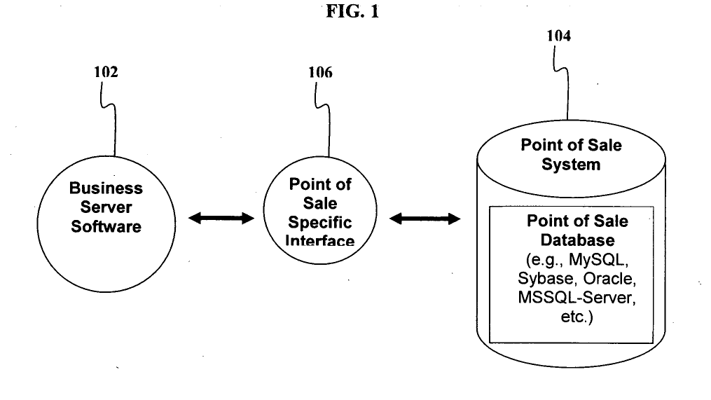

One embodiment of POSSI is illustrated in FIG. 1. The business server software (BSS) 102 does not need to care which capabilities the disparate POS systems 104 offer because an abstraction of the present invention, the POSSI 106, is drawn therebetween. Because of the POSSI 106, all pre-existing POS systems 104 look the same to the BSS 102. This means that the BSS 102 need not change when a POSSI 106 is adapted for use in a disparate POS system 104. The BSS 102 does not change because it contains only the generic capability and communicates with the POSSI 106 via a generic interface, while the POSSI 106 contains the POS specific capability and communicates with the POS system 104 database. POS system 104 schemas are well known within the art and may comprise any suitable manner of components including, but not limited to, a POS database for storing POS system specific data and POS software for importing and exporting POS system specific data to and from the POS database.

Each new POS system/schema combination will require a new system specific POSSI 106. This may sound like a difficult task; however, further analysis has shown that the problem is tractable because the knowledge gained about a POS system 104 is encoded in the POSSI 106 for that system. A POSSI 106 for a particular POS system 104 need only be created one time, thereafter the POSSI 106 is reused for other instances of the same POS system 104. Also, many POS systems 104 rely on the same databases and have similar features. A new POSSI 106 will most frequently be a close cousin of some other similar POSSI 106 that came before. This allows for similarities to be spotted and simple modifications to be made to existing POSSI 106 implementations, as opposed to creating new ones.

Additionally, the space of all POS systems 104 to be interfaced with is larger but finite and clustered within particular industries. This means that as one proceeds, more and more opportunities will be found to reuse existing POSSI 106 implementations. For example, in some areas of retail/commercial industries approximately 75% of the retailers use one of only two POS systems 104. Therefore, POSSI 106 implementations for those POS systems 104 may be created very early, since two POSSI 106 implementations could cover approximately 75% of retailers in such an industry.

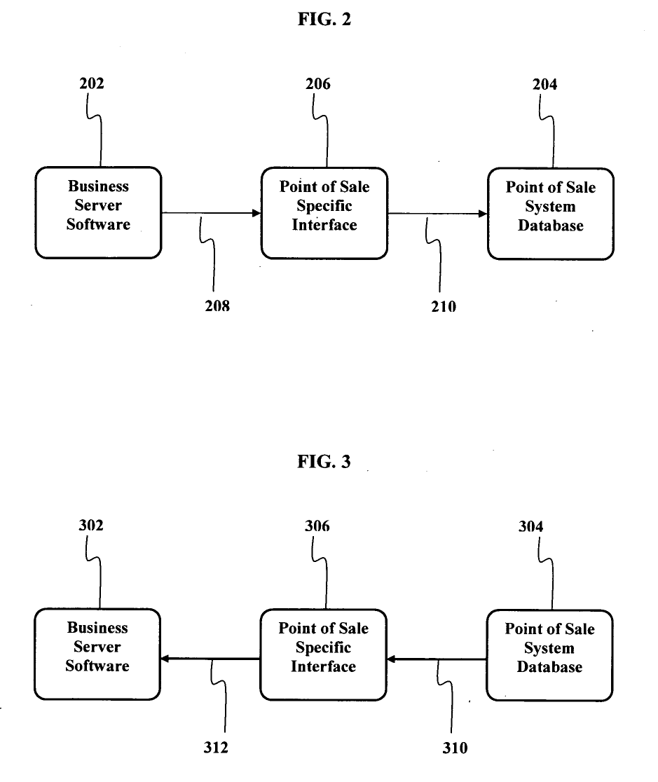

FIG. 2 depicts only one direction of the bidirectional communication flow between the BSS 202, the POSSI 206 and the POS system 204, respectively. The BSS 202 communications to the POSSI 206 are generic and independent of each of the possible disparate POS systems 204. The BSS 202 communicates directive bundles 208 to the POSSI 206. Additionally, the POSSI 206 translates the directive bundles 208 received from the BSS 202 into POS system specific data 210 that is then communicated to the POS system 204, wherein the POS system specific data 210 is written into the database of the POS system 204. The communications between the POSSI 206 and the POS system 204 are specific to each of the possible disparate point of sale systems. In one embodiment, the directive bundles 208 may initially be sent to the BSS 202 by means of an internet connection with a consumer loyalty system.

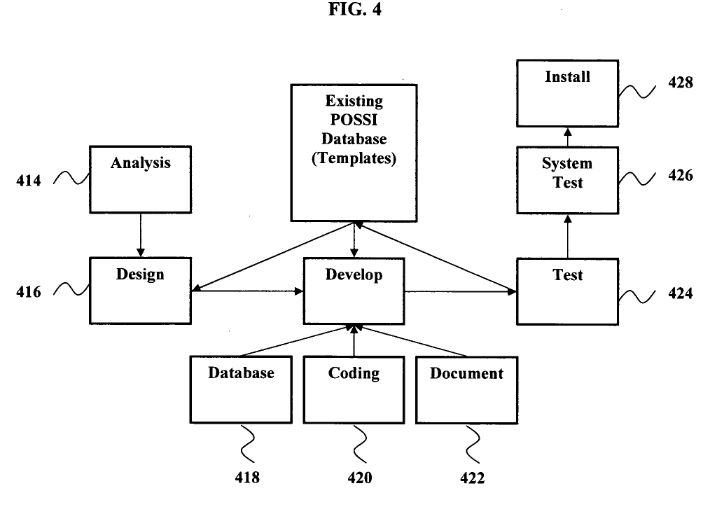

FIG. 3 also depicts only one direction of the bidirectional communication flow between the BSS 302, the POSSI 306 and the POS system 304, respectively. The POS system 304 communications to the POSSI 306 are specific to each of the possible disparate point of sale systems. The POS system 304, having a database, communicates POS system specific data 310 to the POSSI 306, wherein the POSSI 306 translates the received POS system specific data 310 into a generic reward/transaction upload bundle 312. The POSSI 306 then communicates the generic reward/transaction upload bundle 312 to the BSS 302. The POSSI 306 communications to the BSS 302 are generic and independent of each of the possible disparate POS systems. In one embodiment, the BSS 302 may communicate the received upload bundle 312 to a consumer loyalty system by means of an internet connection.

As an example in use, Quickbooks® POS (QBPOS) is run at a large number of small to medium-sized retail locations, with QBPOS supporting a robust Application Programmer's Interface (API), as described above. As illustrated in FIG. 2, the developed POSSI 206 picks apart a directive bundle 208 received from the BSS 202, translates the directive bundle 208 into QBPOS database entries (i.e. POS system specific data 210), and writes those entries to the database of the POS system 204. The BSS 202 may, initially, have received the directive bundle 208 from a central subsystem of a consumer loyalty system. Preferably, directive bundles 208 from such a central subsystem may be sent at regular configurable intervals. Similarly as illustrated in FIG. 3, the POSSI 302 translates POS system specific data 310 received from the database of the QBPOS system 304 into generic reward/transaction upload bundles 312 that can then be sent to the BSS 302. The generic reward/transaction upload bundles 312 may thereafter be sent to a central subsystem of a consumer loyalty system at regular configurable intervals.

FIG. 4 depicts an embodiment of various stages that may be involved in building a new POSSI. During the analysis phase 414, a problem analysis is performed and requirements such as database type, the POS schema, the interface type, recommendations, and any limitations of the POS are communicated to a development team. During the design phase 416, the development team selects the most similar POSSI as a template and passes derived requirements. During the development-database phase 418, the development team adds triggers and discount form selection to the database based on the existing POS's capabilities. During the development-coding phase 420, the development team adds POSSI to the BSS install and creates the specific implementation from the template. During the development-document phase 422, the development team fills out a help template and FAQ, ensures that the POSSI is properly documented, and makes sure any specific help required to use the consumer loyalty system and POSSI with the existing POS system is described within the help pages. During the test phase 424, the development team runs standard factory acceptance testing processes that are established for the product. During the system test phase 426, the development team runs standard site acceptance testing processes established for the product. During the install phase 428, the system is installed and checked out. A technical support team may provide assistance thereafter.

When using a consumer loyalty system in combination with one embodiment of the POSSI of the present invention, certain limitations may need to be communicated to both the participating businesses and consumers. Due to bundle transmissions to and from a central subsystem database at regular configurable intervals, earned rewards/incentives may not be instantly available for redemption. Rewards/incentives will be available as soon as the next calendar day after the reward is earned when bundle communications are sent and received at regular configurable intervals. Similarly, a reward/incentive that is earned may be reusable for a period of time up until the next received bundle transmission acts to remove the redeemed reward/incentive. A participating business' choice of reward/incentive programs available is not limited by the consumer loyalty system or the POSSI, but rather by the restrictions and capabilities of the participating business' particular pre-existing POS system. Similarly, the turnaround time for development of a new POSSI for use at a particular business may be dependent on the complexity of the business' pre-existing POS, similarity of the POS system to prior POSSI implementations, and the number of staff members on the POSSI development team. Questions from both businesses and consumers should be anticipated and used to update the FAQ and customer support database with answers to the anticipated questions. Further, when a business decides to participate in the consumer loyalty system and requires a POSSI to be developed for their pre-existing POS system, visit transaction capability (e.g. an Information Exchange Unit (IEU)) may be immediately installed even if no POSSI implementation is currently available. Initially enabling such visit transaction capability provides the participating business the immediate benefit of being able to identify visiting consumers.

Accordingly the reader will see that, according to one embodiment of the invention, the present invention provides for a unique POS interface that is external to the POS software and allows for communication with pre-existing disparate POS systems. Further, such an interface with disparate POS systems allows for a plurality of businesses, each having their own disparate POS system, to independently participate in a centralized configurable consumer loyalty system, such as that disclosed in the U.S. utility application Ser. No. 11/606,530, filed with the USPTO on Nov. 30, 2006, which has been incorporated by reference in its entirety. In such an embodiment, the BSS may be in bidirectional communication with a central subsystem database of the consumer loyalty system. Such a communication may be provided for by a connection to the internet or World Wide Web, of which there are many varieties well known in the art. Such connections to the World Wide Web include, but are not limited to, DSL, ADSL, cable modem, dial-up telephone, wireless communications utilizing industry standards such as Wi-Fi, and the like. This embodiment of invention is not limited by the type of connection established to the World Wide Web. Furthermore, the connection may be comprised of a combination of types of connections: for example, a wireless Wi-Fi connection to a Wi-Fi hub, which is in turn in communication with the World Wide Web via a high-speed wired connection, such as Ethernet. Such techniques are well known in the computing art.

While the above description contains many specificities, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. An interface for communicating with disparate point of sale systems, comprising:
a software module, comprising:
business server software; and
a point of sale specific interface for bidirectionally translating communications between said business server software and said disparate point of sale system.

2. The interface of claim 1, wherein said disparate point of sale systems each comprise a point of sale database, point of sale system specific data stored on said database, and point of sale software for managing said data on said database.

3. The interface of claim 2, wherein said point of sale specific interface is external to said point of sale software.

4. The interface of claim 3, wherein said business server software has a generic interface.

5. The interface of claim 4, wherein said bidirectionally translated communications between said business server software and said point of sale specific interface are generic and independent of said disparate point of sale systems.

6. The interface of claim 5, wherein said bidirectionally translated communications between said point of sale specific interface and said disparate point of sale system are specific to each of said disparate point of sale systems.

7. The interface of claim 6, wherein said point of sale specific interface translates said point of sale system specific data communicated from said disparate point of sale system into generic reward/transaction upload bundles that are then communicated to said business server software.

8. The interface of claim 7, wherein said point of sale specific interface translates directive bundles that are communicated from said business server software into said point of sale specific data that is then communicated to said disparate point of sale system.

9. The interface of claim 8, wherein said business server software is in communication with a consumer loyalty system, said consumer loyalty system sending said directive bundles to said business server software at regular configurable intervals and said business server software sending said generic reward/transaction upload bundles to said consumer loyalty system at regular configurable intervals.

10. An interface for communicating with disparate point of sale systems, comprising:
business server software having a generic interface;
a point of sale system comprising a point of sale database, point of sale system specific data stored on said database, and point of sale software for managing said data on said database; and
a point of sale specific interface for bidirectionally translating communications between said business server software and said point of sale database.

11. The interface of claim 10, wherein said point of sale specific interface is external to said point of sale software.

12. The interface of claim 11, wherein said bidirectionally translated communications between said business server software and said point of sale specific interface are generic and independent of said disparate point of sale systems.

13. The interface of claim 12, wherein said bidirectionally translated communications between said point of sale specific interface and said point of sale database are specific to each of said disparate point of sale systems.

14. The interface of claim 13, wherein said point of sale specific interface translates said point of sale system specific data communicated from said point of sale database into generic reward/transaction upload bundles that are then communicated to said business server software.

15. The interface of claim 14, wherein said point of sale specific interface translates directive bundles that are communicated from said business server software into said point of sale specific data that is then communicated to said point of sale database.

16. The interface of claim 15, wherein said business server software is in communication with a consumer loyalty system, said consumer loyalty system sending said directive bundles to said business server software at regular configurable intervals and said business server software sending said generic reward/transaction upload bundles to said consumer loyalty system at regular configurable intervals.

17. A method of interfacing disparate point of sale systems, comprising the steps of:
providing business server software having a generic interface;
providing said disparate point of sale system, said disparate point of sale system having a point of sale database, point of sale system specific data stored on said database, and point of sale software for managing said data on said database;
providing a point of sale specific interface for bidirectionally translating communications between said business server software and said point of sale database, said point of sale specific interface being external to said point of sale software, said bidirectionally translated communications between said business server software and said point of sale specific interface are generic and independent of each of said disparate point of sale systems, wherein said bidirectionally translated communications between said point of sale specific interface and said point of sale database are specific to each of said disparate point of sale systems;
translating, via said point of sale specific interface, said point of sale system specific data that is communicated from said point of sale database into generic reward/transaction upload bundles that are then communicated to said business server software; and
translating, via said point of sale specific interface, directive bundles that are communicated from said business server software into said point of sale specific data that is then communicated to said point of sale database.

18. The method of interfacing disparate point of sale systems of claim 17, further comprising the steps of:
communicating said generic reward/transaction upload bundles from said business server software to a consumer loyalty system at regular configurable intervals; and
communicating said directive bundles from said consumer loyalty system to said business server software at regular configurable intervals.

19. The method of interfacing disparate point of sale systems of claim 18, wherein said consumer loyalty system is in communication with said business server software by means of an internet connection.

20. The method of interfacing disparate point of sale systems of claim 19, wherein a reward available via said consumer loyalty system is selected from the group consisting of percentage off total sale, percentage off particular item, cash credit to total sale of certain amount or higher, cash off total sale cash back, and cash off total sale store credit.
